(19) United States
(12) Patent Application Publication
(10) Pub. No.: US 2011/0218277 A1
(43) Pub. Date: Sep. 8, 2011

(54) PRESSURIZED INK COMPOSITIONS AND A BALL POINT PEN COMPRISING THE SAME

(76) Inventors: Manish Babulal Shah, Maharashtra (IN); Manish Swetal Shah, Maharashtra (IN); Vinod Chintamani Malshe, Maharashtra (IN)

(21) Appl. No.: 13/127,961

(22) PCT Filed: Jan. 6, 2009
(86) PCT No.: PCT/IN2009/000019

§ 371 Date: May 5, 2011

(30) Foreign Application Priority Data
Nov. 7, 2008 (IN) 2372/MUM/2008

(51) Int. Cl. C08K 5/1545; C08K 5/138; C08K 5/05; C08K 5/42; C08K 5/16; C08K 5/18; C08K 5/23

(52) U.S. Cl. 524/109; 524/323; 524/384; 524/386; 524/159; 524/249; 524/237; 524/190

(57) ABSTRACT

A pressurized ball point pen ink composition comprising 30-65% of organic solvent, 15-50% of resin, 0.1-3% of viscosity imparting agent, 0.01 to 1% of polyvinyl pyrrolidone, 2 to 20% of lubricant, 5-25% of colorant; and 0.1-5% of amines and/or 0.1 to 20% diols or polyols; amines and/or diols or polyols capable of forming temporary bridging between silica particles at the same time forming associative coupling between amines itself and diols or polyol itself to obtain the ink composition having viscosity of about 10K to 45K cps. The pressurized ball point pen ink composition further comprising higher alcohol as anti-leakage and plasticizing additive in the ink composition to reduce the viscosity of the ink composition from 13K to 15K cps to below 1 0000 cps. The ink composition prevents leakage, bobbling and other defects associated with the prior art at the same time gives pleasure while writing. The pen comprising, the above ink compositions, which are manufactured by the process of the invention.

### TECHNICAL FIELD

This invention relates to pressurized ball point pen ink compositions having viscosity about 10 K to 45K cps at 25° C. preventing leakage due to formation of temporary bridging between functional groups and associative thickening.

This invention also relates to pressurized ball point pen ink compositions having viscosity below 10000 cps preventing leakage due to formation of temporary bridging between functional groups and associative thickening.

This invention also relates to a process for the preparation of pressurized ball point pen ink compositions of the invention.

This invention also relates to a ball point pen comprising the above-mentioned pressurized ball point pen ink compositions.

### PRIOR ART OF THE INVENTION

A ballpoint pen is a writing instrument which features a tip that is automatically refreshed with ink. It consists of a precisely formed metal ball seated in a socket below a reservoir of ink. As the pen is moved along a writing surface, ink is delivered.

A conventionally known oil-based ink for such a ballpoint pen contains coloring agent, organic solvent, resin or the like, and its ink viscosity is in a range of 10000 to 30000 mPa·s at 20° C.

The earlier pens leaked or clogged due to improper viscosity of the ink, and depended on gravity to ink delivery to the ball. Depending upon the gravity it caused difficulties with the flow and that it was required that the pen to be held nearly vertically.

A conventional non-aqueous ball point pen has been designed by setting an ink viscosity in the range of 10,000 to 30,000 mPa·s at 20° C. to prevent leakage. The use of high viscosity ink increases the ball rotation resistance during writing and it affects writing smoothness and fails to be satisfactory. Further, a high writing pressure is required during writing. In some cases, a load of 500 gf or more is applied to a pen point. The heavy load causes a pen point to be damaged instantly. Furthermore, ball breakage and writing defects frequently occur as a consequence.

One of the writing defects is Blobbing that is a phenomenon in which a surplus ink during writing is accumulated in a pen point. Another defect is “Feathering” which is blurring of the ink due to absorption by paper etc.

There are various Japanese Patent Application laid-open nos. 6-313143 (1994), 6-313144 (1994), 7-196972 (1995) and 9-48941 (1997) that disclose ink consisting of pseudo plasticity viscosity property in which the ink viscosity during writing is low and ink viscosity is high when writing is not performed. However, leakage is not prevented completely.

The following are the prior arts which discuss prevention of leakage by achieving high viscosity by using different additives:

U.S. Pat. No. 6,503,966 discloses the non-aqueous ball point pen ink consisting of the colorant; the organic solvent; the non-Newtonian viscosity imparting agent such as fatty acid amide wax with a melting temperature of 140° C. or more; and a thickening agent such as polyvinyl pyrrolidone with a weigh-average molecular weight of about 40,000 to 55,000. The non-Newtonian viscosity index of the ink is not less than 0.1 and less than 0.4, a viscosity of the ink in a shearing speed of 500 sec⁻¹ is not less than 1,000 and less than 3,000 mPa-s at 20° C., and the viscosity of the ink in the shearing speed of 0.19 sec⁻¹ is not less than 40,000 mPa-s at 20° C. and not more than 70,000 mPa-s at 20° C.

U.S. Pat. No. 6,479,568 discloses the ink consisting of two types of polyvinyl pyrrolidone having different weight-average molecular weights to eliminate ink blobbing and scratching. The first polyvinyl pyrrolidone with a weight-average molecular weight of about 1,000,000 to 1,500,000 and the second polyvinyl pyrrolidone with a weight-average molecular weight of about 2,500,000 to 3,000,000 are used in the above mentioned ink.

U.S. Pat. No. 7,303,350 discloses the ink composition for a pressurized ballpoint pen consisting of at least a colorant, a solvent and silica. The coagulated matter of the ink consisting of at least silica and the ink composition has a viscosity of 10000 to 40000 mPa·s at 25° C.

U.S. Pat. No. 6,441,061 discloses the additive for an oil based ink for a ball point pen. The ink consists of at least one or plural kinds of organic solvents, a resin and an inorganic fine particle thickener. The additive has a viscosity of 1000 mPa·s or more at a shear rate of 5/s and at 0° C. and a viscosity of 50000 mPa·s or less at a shear rate of 5/s and 50° C. and has a non-Newtonian index of from 0.30 to 0.95. The additive has an absorbance of from 0.01 to 5 at a wavelength of 900 nm when a cell is 1 cm long. The specific surface area (BET method) of said inorganic fine particle thickener ranges from 30 to 500 m<2>/g and an average diameter of the primary particles thereof ranges from 5 to 50 nm. The inorganic fine particle thickener comprises inorganic fine particles containing SiO2 of 70% by weight or more.

Ball point pens filled with conventional inks have a viscosity of 5000 to 20000 mPa-s at 25°. Sometimes ink leak from the pen tips happen when the ball point pens have been irradiated directly with sunlight to have the temperatures of the pen bodies elevated, or when the ball point pens have been left turning downward for long time. Ball point pens filled with inks having a low viscosity of 1000 to 5000 mPa-s at 25° C. shows such tendency more markedly. Increasing the drying property of inks in order to stop leaking of the inks brings about the problems of deterioration in the writing feeling, starving at the beginning of writing and reduction in the shelf life. Furthermore, inks leaking out of the pen tips of ball point pens stain hands and cloths or make it impossible to use the ball point pens in a certain case. Accordingly, it is the current situation to prevent inks from leaking by reducing clearance of tips, and thus the writing feeling tends to be deteriorated.

U.S. Pat. No. 5,942,027 discloses the ink for a ball point pen which comprises at least one or plural kinds of organic solvents, colorants and resins and fine particle silica having a primary average particle diameter of 7 to 40 nm and a specific surface area (BET method) of 50 to 380 m@2/g. The ink for a ball point pen comprises polyvinyl pyrrolidone as an additive. The ink for a ball point pen has a viscosity of 1000 to 5000 mPa-s at 25° C.

U.S. Pat. No. 6,530,708 discloses the ink follower composition for oil-based ballpoint pens. The ink composition comprises at least one organic solvent selected from the group consisting of a sparingly volatile organic solvent and a non-volatile organic solvent, a gelling agent comprising inorganic fine particles, and from 10 to 60% by weight of a resin soluble in the organic solvent used. The resin is terpene-base resins and phenol-base resins. The inorganic fine particles are fine particulate silica. However, U.S. Pat. No. 3,425,779 uses colloidal silica to prepare ink composition having viscosity of 874,000 cps at 28° C. with a No 4 cylindrical spindle at 0.3 rpm on Brookfield viscometer.

JP 2003191680 discloses a ballpoint pen with which handwriting is clear and write-ability is good without bleeding, strike through and clogging, in the ballpoint pen having a ballpoint pen tip rotate-ably supporting a writing point ball in a ball holding state and filled with an oily ink. The oily ink consists of coloring gent, organic solvent, non-Newtonian viscosity imparting agent and C₄ aliphatic alcohol. The non-Newtonian viscosity index is 0.4 to 0.9 and viscosity at a shearing speed of 500 sec⁻¹ is 500 to 5000 pas at 20° C.

### OBJECTS OF THE INVENTION

An object of the invention is to provide a pressurized ball point pen ink having viscosity of about 10K to 45K cps which prevents leakage, bobbling, feathering and other defects associated with the prior art.

Another object of the invention is to provide the pressurized ball point pen ink having viscosity of about 10K to 45K cps wherein compounds having functional groups (hereinafter referred as Associative thickening agent/additives) capable of forming temporary bridging between silica particles at the same time forming associative coupling between associative thickening agent/additives thereby increasing viscosity with reducing amount of silica particles and also amount of PVP thus making product, the ink composition cost-effective as associative thickening agent/additives are less expensive than that of silica particles and PVP.

Another object of the invention is to provide the pressurized ball point pen ink having viscosity of about 10K to 45K cps wherein compounds having functional groups (hereinafter referred as Associative thickening agent/additives) capable of forming temporary bridging between silica particles at the same time forming associative coupling between associative thickening agent/additives thereby forming network which breaks while writing and reforms on standing giving feeling of smoothness.

Another object of the invention is to provide the pressurized ball point pen ink having viscosity of about 10K to 45K cps wherein the higher alcohol is more volatile solvent thus evaporates faster at the point of discharge of ball point pen and forming a thin film at the point of discharge thus prevents leakage.

Another object of the invention is to provide the pressurized ball point pen ink having viscosity below 10000 cps wherein compounds having functional groups (hereinafter referred as Associative thickening agent/additives) capable of forming temporary bridging between silica particles at the same time forming associative coupling between associative thickening agent/additives thereby forming network which breaks while writing and reforms on standing giving smoothness feeling.

Another object of the invention is to provide the pressurized ball point pen ink having viscosity below 10000 cps wherein the higher alcohol is more volatile solvent thus evaporates faster at the point of discharge of ball point pen and forming a thin film at the point of discharge thus prevents leakage.

Another object of the invention is to provide processes for the preparation of the above-mentioned ink compositions.

Yet another object of the invention is to provide ball point pens comprising the above-mentioned ink compositions.

### DETAILED DESCRIPTION

Associative thickening agent/additives referred in the specification are intended to cover amines including monoamines, diamines or polyamines or alcohols including diols, triols or polyols.

Amines referred in the specification are intended to cover monoamines, diamines or polyamines.

According to the invention, there is provided a pressurized ball point pen ink composition having viscosity of about 10K to 45K cps at 25° C. with a No 21 cylindrical spindle at 1 rpm on Brookfield viscometer;

the composition comprising:
30-65% of organic solvent, 15-50% of resin, 0.1 to 3% of viscosity imparting agent; 0.01-1% of polyvinyl pyrrolidone; 0.5 to 20% of lubricant; 5-30% of colorant; and 0.1-5% of amines and/or 0.1 to 20% diols or polyols; amines and/or diols or polyols capable of forming temporary bridging between silica particles at the same time forming associative coupling between amines itself and diols or polyol itself to obtain the ink composition having viscosity of about 10K to 45K cps.

The pressurized ball point pen ink composition further comprising higher alcohol as anti-leakage and plasticizing additive in the ink composition to reduce the viscosity of the ink composition from 10K to 45K cps to below 10000 cps at 25° C. with a No 21 cylindrical spindle at 1 rpm on Brookfield viscometer.

According to the invention, there is provided a process for the preparation of a pressurized ball point pen ink composition having viscosity of about 10K to 45K cps at 25° C. with a No 21 cylindrical spindle at 1 rpm on Brookfield viscometer;

the process comprising;
a. preparing homogenous mixture by mixing resin in organic solvent and polyvinyl pyrrolidone and heating the mixture with stirring at temperature up to 100° C.;
b. adding amines and/or diols or polyols as associative thickening agent/additives to the homogeneous mixture followed by adding fume silica in the above mixture and mixing to form a fine homogeneous mixture;
c. preparing a dye solution by adding organic solvent to lubricant and a dye with stirring;
d. adding the mixture obtained in step (b) to the dye solution with stirring for at least 30 minutes followed by cooling to obtain the ink composition having viscosity about 10K to 45K cps at 25° C.

The process further comprises adding higher alcohol as anti-leakage and plasticizing additive to the ink composition to obtain the ink composition having viscosity below 10000 cps at 25° C. with a No 21 cylindrical spindle at 1 rpm on Brookfield viscometer.

According to the invention, there is provided a ball point pen comprising the abovementioned ink composition having viscosity about 10 K to 45 K cps or viscosity below 10000 cps of the invention which preventing leakage, bobbling, gooping, gobbling and gives pleasure in writing being smoothly.

The organic solvent is selected from ethylene glycol, monophenyl ether, benzyl alcohol, phenoxy ethanol, propylene glycol, dipropylene glycol, 1,3-butylene glycol, hexylene glycol, ethyl carbitol, tetralin, propylene glycolmonophenyl ether, dipropylene glycol monomethyl ether, dipropylene glycol monobutyl ether, dipropylene glycol monomethyl ether acetate, tripropylene glycolmonomethyl ether or N-methyl-2-pyrrolidone, etc. Moreover, each of these organic solvents may be used alone, or two or more of them may be appropriately combined to use.

The organic solvent used is preferably 45% to 60% by weight of the total amount of ink composition.

The resins used are selected from ketone, phenol resins, mallein resins, xylene resins, polyethylene oxide, rosin resins, rosin derivatives, terpene based resins, chroman-indene resins, polyvinyl butyral, polyvinyl pyrrolidone, vinyl pyrrolidone-vinyl acetate copolymers, polymethacrylates or polyacrylic acid-polymethacrylic acid copolymers, etc.

Moreover, these resins may be used alone, or two or more of them may be appropriately combined to use. Preferably, the resin used in the above ink is Ketonic Resin or Maleic resins or combination thereof.

The resin used is preferably 25% to 45% by weight of the total amount of ink composition.

The structural viscosity imparting agent used is selected from inorganic fine particles such as carbon black, particulate silica (different grade of Aerosyl), etc. Moreover, each of these inorganic fine particles may be used alone, or two or more of them may be appropriately combined to use. The content of structural viscosity imparting agent is preferably 0.25 to 2% by weight of the total amount of ink composition. Viscosity imparting agent is added in the form of homogeneous mixture in extremely fine particle form. The viscosity agent is homogeneously mixed in solvent selected from above list of solvents.

The colorants used in the ink composition are dyes or pigments that have been used for oil-based ball-point pens. Specifically, e.g., dyes used are solvent dyes and base dyes which may be cationic or anionc such as BASF VALIFAST colors (trade name, Orient Chemical Industries, Ltd.), NIGROSINE EX (trade name, Orient Chemical Industries, Ltd.), Eisen Spiron dye, Eisen SOT dye (trade name, Hodogaya Chemical Co., Ltd.), Spiron Violet C—RH (trade name, Hodogaya Chemical Co., Ltd.), Spiron Yellow C-2 GH (trade name, Hodogaya Chemical Co., Ltd.), etc. The inorganic pigments used are selected from titanium oxides, carbon black, Carbon Black MA-100 (trade name, Mitsubishi Chemical Co., Ltd.), metal powders, etc. The organic pigments used are selected from azo lakes, insoluble azo pigments, chelate azo pigments, phthalocyanine pigments, perylene pigments, anthraquinone pigments, quinacridone pigments, dye lakes, nitro pigments, nitroso pigments, etc. Moreover, each of dyes or pigments described above may be used alone, or two or more of them may be appropriately combined to use. The colorant is preferably 10 to 24% by weight of the total amount of ink composition. The selection of dye and pigment will be dependent upon the colour of the ink.

Polyvinyl pyrrolidone is used as an additive to prevent gooping, blobbing, blotting, bleeding, and globbing. The polyvinyl pyrrolidone used in the ink composition is 100,000 to 15,000,000 mol weight.

The amine is selected from primary, secondary and tertiary aliphatic, cycloaliphatic, or aromatic amine such as butyl amine, hexyl amine, 2-ethyl hexyl amine, octyl amine, decyl amine, dodecyl amine, cetyl amine, palmityl amine, ricinolyl amine, oleyl amine, steryl amine, cyclo hexyl amine, abetyl amine, picolin, pyridine and its higher homologues; 2-amino pyridine, piperazene, ethylene diamine, diethylene tri-amine, triethylene tetra-amine; polyamines such as n-alkyl propylene diamine where alkyl group is selected from C₂ to C₂₄, etc. Moreover, these amines or polyamines may be used alone, or two or more of them may be appropriately combined to use. Preferably, the amines used in the above ink are oleyl amine, ethylene diamine or diethylene triamine.

The diols or polyols are selected from ethylene glycol, propylene glycol, di-ethylene glycol, di-propylene glycol and poly ethylene oxide derivatives, polypropylene oxide derivatives, co condensates of ethylene oxide and propylene oxide, random or block copolymers of ethylene oxide and propylene oxide ranging from 200 to 2000 molecular weights, glycerine, ethylene oxide condensates of glycerin, penta erythritol and its ethylene oxide condensates and propylene oxide condensates, random or block copolymers of polycondensation products from 2 to 200 moles, sorbitol, hexitol, butane-1,4-diol, butane-1,2-diol, butane-1,3-diol, 2-methyl pentane-1,5-diol, hexane-1,6-diol, octane-1,8-diol, decane-1,10-diol, dodecane-1,12-diol, and the like. Moreover, these diols or polyols may be used alone, or two or more of them may be appropriately combined to use. Preferably, the diols or polyol used is preferably Carbopol.

The amine used in the ink composition is preferably 0.2 to 2.5% wt/wt. The diols and/or polyols used in the ink composition are preferably 0.2 to 10% wt/wt.

Moreover, one or more of these polyamines may be used alone, or in combination with one or more polyol appropriately combined to use.

The higher alcohol is selected from any suitable fast evaporating solvents as anti-leakage, and plasticizing additive in the ink of the invention. The higher alcohols are selected from benzyl alcohol, octane-1-ol, octane-2-ol, dodecyl alcohol, steryl alcohol, cetosteryl alcohol, methoxy benzyl alcohol, methyl benzyl alcohol, dimethyl benzyl alcohol, trimethyl benzyl alcohol, tetramethyl benzyl alcohol and pentamethyl benzyl alcohol, C₁-C₄ alkoxy substituted benzyl alcohol and its homologues.

Moreover, these higher alcohols used alone, or two or more of them may be appropriately combined to use. Preferably, the higher alcohol used in the above ink is Benzyl alcohol.

The higher alcohol used is preferably 6% to 20% by weight of the total amount of ink composition.

A lubricant used in the ink composition is selected from phosphoric acid ester, Stearic acid, Oleic acid and other fatty acids. Moreover, these lubricants used alone, or two or more of them may be appropriately combined to use. Preferably, the lubricants used in the above ink are phosphoric acid ester or Oleic acid or in combination.

The lubricant used is preferably 2% to 20% by weight of the total amount of ink composition.

According to the invention, polyamine or polyol used as associative thickening agent/additives which forms temporary bridging between silica particles and simultaneously forms associative coupling between polyamines and/or polyol to obtain network of the same. The formation of network gives the ink composition having viscosity of about 13K to 15K cps as measured by Brookfield Viscometer spindle No 21 at 1 Rpm. When this value is extrapolated to zero sheer, the values may reach very high in static conditions of storage. The use of associative thickening agent/additives to bond/couple silica particles reduces the amount of silica particles required from about 3% to less than 2% percent and also amount of PVP to less than 1% to achieve/obtain ink having viscosity of about 10K to 45K cps at 25° C. at 25° C. with a No 21 cylindrical spindle at 1 rpm on Brookfield viscometer. Thus, making the process and ink composition cost-effective as amines or diols or polyols are less expensive than that of silica particles and PVP. The ink composition having viscosity below 10000 cps by using higher alcohol and preventing leakage, bobbling, etc which are generally problems associated with prior art. The writing pleasure of the ink depends also upon the viscosity of the ink and is inversely proportional to the viscosity. Thus, the ink compositions have advantage of smooth writing and thereby give pleasure experience while writing. The higher alcohol is used in the invention as anti-leakage and plasticizing additives against the prior art where the same is generally used as a co-solvent or primary solvent for manufacturing inks. Further the ink having less viscosity; particularly less than 10,000 cps has difficulty stopping the leakage and long term stability for withstanding the pressure while working under pressure but the present ink composition works well under pressure without leakage, bobbling or another defects.

The invention will be more clearly understood by reference to the following examples, which however are intended only to illustrate the invention and are not to be construed as limiting the scope of the invention.

### Example 1

### Blue Ink Composition with Amine

20 gms of phenoxy ethanol was added to 5 gms of ethyl carbitol, 50 gms resin (SK 100) and 0.100 gms PVP K90. The mixture was heated up to 100° C. along with stirring to dissolve the resin. To this mixture, 0.5 gm of oleyl amine was added and to obtain homogeneous mixture. 1 gm of fume silica was mixed with the above mentioned mixture with stirring to obtain a mixture.

10 gms of phenoxy ethanol was added to 10 gms of phosphoric acid ester, 18 gms of benzyl alcohol, 8 gms Oelic Acid, 10 gms of Solvent Violet 8, 4 gms of Solvent Blue 4 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition the Benzyl alcohol was added to reduce the viscosity below 10000 cps.

The ink composition prepared was tested for leakage and writing smoothness. The results are tabulated in Table 1.

### Comparative Example 2

### Blue Ink Composition with Out Amine

20 gms of phenoxy ethanol was added to 5 gms of ethyl carbitol, 50 gms resin (SK 100) and 1 gm PVP K90. The mixture was heated up to 100° C. along with stirring to dissolve the resin. To this mixture, 1 gm of fume silica was added with stirring to obtain a mixture.

10 gms of phenoxy ethanol was added to 10 gms of phosphoric acid ester, 18 gms of benzyl alcohol, 8 gms Oelic Acid, 10 gms of Solvent Violet 8, 4 gms of Solvent Blue 4 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition the Benzyl alcohol was added to reduce the viscosity below 10000 cps.

The ink composition prepared was tested for leakage and writing smoothness. The results are tabulated in Table 1.

### Comparative Example 3

### Blue Ink Composition without Amine

20 gms of phenoxy ethanol was added to 5 gms of ethyl carbitol and 50 gms resin (SK 100). The mixture was heated up to 100° C. along with stirring to dissolve the resin. To this mixture, 1 gm of fume silica was added with stirring to obtain a mixture.

10 gms of phenoxy ethanol was added to 10 gms of phosphoric acid ester, 18 gms of benzyl alcohol, 8 gms Oelic Acid, 10 gms of Solvent Violet 8, 4 gms of Solvent Blue 4 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition the Benzyl alcohol was added to reduce the viscosity below 10000 cps.

The ink composition prepared was tested for leakage and writing smoothness. The results are tabulated in Table 1.

### Comparative Example 4

### Blue Ink Composition without Amine

20 gms of phenoxy ethanol was added to 5 gms of ethyl carbitol and 50 gms resin (SK 100). The mixture was heated up to 100° C. along with stirring to dissolve the resin. To this mixture, 4.5 gm of fume silica was added with stirring to obtain a mixture.

10 gms of phenoxy ethanol was added to 10 gms of phosphoric acid ester, 18 gms of benzyl alcohol, 8 gms Oelic Acid, 10 gms of Solvent Violet 8, 4 gms of Solvent Blue 4 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition the Benzyl alcohol was added to reduce the viscosity below 10000 cps.

The ink composition prepared was tested for leakage and writing smoothness. The results are tabulated in Table 1.

TABLE 1
Results of Examples 1 to 4

| | | Comparative | Comparative | Comparative |
|---|---|---|---|---|
| Particulars | Example 1 | Example 2 | Example 3 | Example 4 |
| Solvent | | | | |
| Phenoxy Ethanol | 30 | 30 | 30 | 30 |
| DEG | 10 | 10 | 10 | 10 |
| Benzyl Alcohol | 18 | 18 | 18 | 18 |
| Resin and Binders | | | | |
| Synthetic resin | 50 | 50 | 50 | 40 |
| Aerosil | 1.5 | 1.5 | 1.5 | 4.5 |
| PVP | 0.1 | 1 | 0 | 0 |
| Colourants | | | | |
| Solvent Violet 8 | 10 | 10 | 10 | 26 |
| Solvent Blue 4 | 4 | 4 | 4 | 4 |
| Lubricant | | | | |
| Additive | | | | |
| & Dye solubilizer | | | | |
| Oelic Acid | 8 | 8 | 8 | 8 |
| Phosphoric Acid | 10 | 10 | 10 | 10 |
| Ester | | | | |
| Oleyl Amine | 0.5 | 0 | 0 | 0 |
| Result | | | | |
| Leakage | Θ | Θ | X | Θ |
| Writing | Θ | 0 | 0 | X |

Wherein:
Θ - Excellent;
0 - Moderate;
X - Bad/Poor

Metal refills were made out of the above inks using 1.00 mm ball dia tips and were pressurized to contain 20-24 psi pressure and were left in downward position for 7 days for the leakage test after 24 hours in horizontal position, and were hand written for the write test and the smooth feel while writing.

### Leakage

The refills which leaked out from nil to slight were marked as “X” (Excellent);

The refills which leaked moderately to Slight were marked as “0” (Moderate);

The refills which leaked out tremendously to moderately were marked as “X” (Poor).

### Writing Property

The refills which wrote excellently with no gouping and smooth feel were marked as “X “(Excellent);

The refills which wrote moderately with Slight gouping or lesser smooth feel were marked as “0” (Moderate);

The refills which wrote poor with more gouping or hard feel were marked as “X” (Poor).

### Example 5

Black Ink Composition with Amine

20 gms of phenoxy ethanol was added to 5 gms of ethyl carbitol, 50 gms resin (SK 100) and 0.100 gms PVP K90. The mixture was heated up to 100° C. along with stirring to dissolve the resin. To this mixture, 0.5 gm of oleyl amine was added and to obtain homogeneous mixture. 1 gm of fume silica was mixed with the above mentioned mixture with stirring to obtain a mixture.

10 gms of phenoxy ethanol was added to 10 gms of phosphoric acid ester, 18 gms of benzyl alcohol, 8 gms Oelic Acid, 26 gms of Solvent Black 46, 4 gms of Solvent Orange 3 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition the Benzyl alcohol was added to reduce the viscosity below 10000 cps.

The ink composition prepared was tested for leakage and writing smoothness. The results are tabulated in Table 2.

### Comparative Example 6

### Black Ink Composition with Out Amine

20 gms of phenoxy ethanol was added to 5 gms of ethyl carbitol, 50 gms resin (SK 100) and 1 gm PVP K90. The mixture was heated up to 100° C. along with stirring to dissolve the resin. To this mixture, 1 gm of fume silica was added with stirring to obtain a mixture.

10 gms of phenoxy ethanol was added to 10 gms of phosphoric acid ester, 18 gms of benzyl alcohol, 8 gms Oelic Acid, 26 gms of Solvent Black 46, 4 gms of Solvent Orange 3 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition, the Benzyl alcohol was added to reduce the viscosity below 10000 cps.

The ink composition prepared was tested for leakage and writing smoothness. The results are tabulated in Table 2.

### Comparative Example 7

### Black Ink Composition without Amine

20 gms of phenoxy ethanol was added to 5 gms of ethyl carbitol and 50 gms resin (SK 100). The mixture was heated up to 100° C. along with stirring to dissolve the resin. To this mixture, 1 gm of fume silica was added with stirring to obtain a mixture.

10 gms of phenoxy ethanol was added to 10 gms of phosphoric acid ester, 18 gms of benzyl alcohol, 8 gms Oelic Acid, 26 gms of Solvent Black 46, 4 gms of Solvent Orange 3 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition the Benzyl alcohol was added to reduce the viscosity below 10000 cps.

The ink composition prepared was tested for leakage and writing smoothness. The results are tabulated in Table 2.

### Comparative Example 8

### Black Ink Composition without Amine

20 gms of phenoxy ethanol was added to 5 gms of ethyl carbitol and 50 gms resin (SK 100). The mixture was heated up to 100° C. along with stirring to dissolve the resin. To this mixture, 4.5 gm of fume silica was added with stirring to obtain a mixture.

10 gms of phenoxy ethanol was added to 10 gms of phosphoric acid ester, 18 gms of benzyl alcohol, 8 gms Oelic Acid, 26 gms of Solvent Black 46, 4 gms of Solvent Orange 3 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition, the Benzyl alcohol was added to reduce the viscosity below 10000 cps.

The ink composition prepared was tested for leakage and writing smoothness. The results are tabulated in Table 2.

TABLE 2
Results of Examples 5 to 8

| | | Comparative | Comparative | Comparative |
|---|---|---|---|---|
| Particulars | Example 5 | Example 6 | Example 7 | Example 8 |
| Solvent | | | | |
| Phenoxy Ethanol | 30 | 30 | 30 | 30 |
| DEG | 10 | 10 | 10 | 10 |
| Benzyl Alcohol | 18 | 18 | 18 | 18 |
| Resin and Binders | | | | |
| Synthetic resin | 40 | 40 | 40 | 40 |
| Aerosil | 1.5 | 1.5 | 1.5 | 4.5 |
| PVP | 0.1 | 1.5 | 0 | 0 |
| Colourants | | | | |
| Solvent Black 46 | 26 | 26 | 26 | 26 |
| Solvent Orange 3 | 4 | 4 | 4 | 4 |
| Lubricant | | | | |
| Additive & Dye | | | | |
| soulbilizer | | | | |
| Oelic Acid | 6 | 6 | 6 | 6 |
| Phosphoric Acid | 10 | 10 | 10 | 10 |
| Ester | | | | |
| Oleyl Amine | 0.5 | 0 | 0 | 0 |
| Result | | | | |
| Leakage | Θ | Θ | X | Θ |
| Writing | Θ | 0 | 0 | X |

Wherein:
Θ - Excellent;
0 - Moderate;
X - Bad/Poor

### Example 9

### Red Ink Composition with Amine

20 gms of phenoxy ethanol was added to 5 gms of ethyl carbitol, 50 gms resin (SK 100) and 0.100 gms PVP K90. The mixture was heated up to 100° C. along with stirring to dissolve the resin. To this mixture, 0.5 gm of oleyl amine was added and to obtain homogeneous mixture. 1 gm of fume silica was mixed with the above mentioned mixture with stirring to obtain a mixture.

10 gms of phenoxy ethanol was added to 10 gms of phosphoric acid ester, 18 gms of benzyl alcohol, 8 gms Oelic Acid, 16 gms of Solvent Red 49 and 8 gms of Solvent Orange 3 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition the Benzyl alcohol was added to reduce the viscosity below 10000 cps.

The ink composition prepared was tested for leakage and writing smoothness. The results are tabulated in Table 3.

### Comparative Example 10

### Red Ink Composition with Out Amine

20 gms of phenoxy ethanol was added to 5 gms of ethyl carbitol, 50 gms resin (SK 100) and 1 gm PVP K90. The mixture was heated up to 100° C. along with stirring to dissolve the resin. To this mixture, 1 gm of fume silica was added with stirring to obtain a mixture.

10 gms of phenoxy ethanol was added to 10 gms of phosphoric acid ester, 18 gms of benzyl alcohol, 8 gms Oelic Acid, 16 gms of Solvent Red 49 and 8 gms of Solvent Orange 3 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition, the Benzyl alcohol was added to reduce the viscosity below 10000 cps.

The ink composition prepared was tested for leakage and writing smoothness. The results are tabulated in Table 3.

### Comparative Example 11

### Red Ink Composition without Amine

20 gms of phenoxy ethanol was added to 5 gms of ethyl carbitol and 50 gms resin (SK 100). The mixture was heated up to 100° C. along with stirring to dissolve the resin. To this mixture, 1 gm of fume silica was added with stirring to obtain a mixture.

10 gms of phenoxy ethanol was added to 10 gms of phosphoric acid ester, 18 gms of benzyl alcohol, 8 gms Oelic Acid, 16 gms of Solvent Red 49 and 8 gms of Solvent Orange 3 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition the Benzyl alcohol was added to reduce the viscosity below 10000 cps.

The ink composition prepared was tested for leakage and writing smoothness. The results are tabulated in Table 3.

### Comparative Example 12

### Red Ink Composition without Amine

20 gms of phenoxy ethanol was added to 5 gms of ethyl carbitol and 50 gms resin (SK 100). The mixture was heated up to 100° C. along with stirring to dissolve the resin. To this mixture, 4.5 gm of fume silica was added with stirring to obtain a mixture.

10 gms of phenoxy ethanol was added to 10 gms of phosphoric acid ester, 18 gms of benzyl alcohol, 8 gms Oelic Acid, 16 gms of Solvent Red 49 and 8 gms of Solvent Orange 3 with stirring till the total dye was dissolved.

The homogeneous mixture was mixed with the dye solution with stirring for at least 30 minutes. The ink composition was allowed to cool and the viscosity measured at 25° C. at 1 rpm was about 10K to 45K cps. To the ink composition, the Benzyl alcohol was added to reduce the viscosity below 10000 cps.

The ink composition prepared was tested for leakage and writing smoothness. The results are tabulated in Table 3.

TABLE 3
Results of Examples 9 to 12

| | | Comparative | Comparative | Comparative |
|---|---|---|---|---|
| Particulars | Example 9 | Example 10 | Example 11 | Example 12 |
| Solvent | | | | |
| Phenoxy Ethanol | 30 | 30 | 30 | 30 |
| DEG | 10 | 10 | 10 | 10 |
| Benzyl Alcohol | 18 | 10 | 10 | 10 |
| Resin and Binders | | | | |
| Synthetic resin | 50 | 50 | 50 | 50 |
| Aerosil | 1.5 | 1.5 | 1.5 | 4.5 |
| PVP | 0.1 | 1.5 | 0 | 0 |
| Colourants | | | | |
| Solvent Red 49 | 16 | 16 | 16 | 16 |
| Solvent Orange 3 | 8 | 8 | 8 | 8 |
| Lubricant | | | | |
| Additive | | | | |
| & Dye soulbilizer | | | | |
| Oelic Acid | 6 | 6 | 6 | 6 |
| Phosphoric Acid | 10 | 10 | 10 | 10 |
| Ester | | | | |
| Oleyl Amine | 0.5 | 0 | 0 | 0 |
| Result | | | | |
| Leakage | Θ | Θ | X | θ |
| Writing | Θ | 0 | 0 | X |

Wherein:
Θ - Excellent;
0 - Moderate;
X - Bad/Poor

1. A pressurized ball point pen ink composition having viscosity of about 10K to 45K cps at 25° C.;
the composition comprising:
30-65% of organic solvent, 15-50% of resin, 0.1-3% of viscosity imparting agent, 0.01 to 1% of polyvinyl pyrrolidone, 0.5 to 20% of lubricant, 5-30% of colorant; and 0.1-5% of amines and/or 0.1 to 20% diols or polyols; amines and/or diols or polyols capable of forming temporary bridging between silica particles at the same time forming associative coupling between amines itself and diols or polyol itself to obtain the ink composition having viscosity of about 10K to 45K cps.

2. The pressurized ball point pen ink composition as claimed in claim 1 further comprising higher alcohol as anti-leakage and plasticizing additive in the ink composition to reduce the viscosity of the ink composition from 10K to 45K cps to below 10000 cps.

3. The pressurized ball point pen ink composition as claimed in claim 1, wherein the organic solvent is selected from ethylene glycol, monophenyl ether, benzyl alcohol, phenoxy ethanol, propylene glycol, dipropylene glycol, 1,3-butylene glycol, hexylene glycol, ethyl carbitol, tetralin, propylene glycolmonophenyl ether, dipropylene glycol monomethyl ether, dipropylene glycol monobutyl ether, dipropylene glycol monomethyl ether acetate, tripropylene glycolmonomethyl ether, N-methyl-2-pyrrolidone or combinations thereof.

4. The pressurized ball point pen ink composition as claimed in claim 1, wherein the organic solvent used is preferably 45 to 60% by weight of the total amount of ink composition.

5. The pressurized ball point pen ink composition as claimed in claim 1, wherein the resins used are selected from ketone, phenol resins, malleic resins, xylene resins, polyethylene oxide, rosin resins, rosin derivatives, terpene based resins, chroman-indene resins, polyvinyl butyral, polyvinyl pyrrolidone, vinyl pyrrolidone-vinyl acetate copolymers, polymethacrylates, polyacrylic acid-polymethacrylic acid copolymers or combinations thereof.

6. The pressurized ball point pen ink composition as claimed in claim 5, wherein the resin used in the above ink is preferably Ketonic Resin or Maleic resins or combination thereof.

7. The pressurized ball point pen ink composition as claimed in claim 1, wherein the resin used in the above ink is preferably 25 to 45% by weight of the total amount of ink composition.

8. The pressurized ball point pen ink composition as claimed in claim 1, wherein the structural viscosity imparting agent used is selected from inorganic fine particles such as carbon black or particulate silica.

9. The pressurized ball point pen ink composition as claimed in claim 1, wherein the content of structural viscosity imparting agent is preferably 0.25% to 2% by weight of the total amount of ink composition.

10. The pressurized ball point pen ink composition as claimed in claim 1, wherein the colorants used in the ink composition are cationic or anionic Base Dyes, cationic or anionic Solvent dyes or organic pigments selected from azo lakes, insoluble azo pigments, chelate azo pigments, phthalocyanine pigments, perylene pigments, anthraquinone pigments, quinacridone pigments, dye lakes, nitro pigments or nitroso pigments.

11. The pressurized ball point pen ink composition as claimed in claim 11, wherein the colorant is preferably 10 to 24% by weight of the total amount of ink composition.

12. The pressurized ball point pen ink composition as claimed in claim 1, wherein the polyvinyl pyrrolidone used in the ink composition is 100,000 to 15,000,000 mol weight.

13. The pressurized ball point pen ink composition as claimed in claim 1, wherein the amine is selected from primary, secondary and tertiary aliphatic, cycloaliphatic, or aromatic amine such as butyl amine, hexyl amine, 2-ethyl hexyl amine, octyl amine, decyl amine, dodecyl amine, cetyl amine, palmityl amine, ricinolyl amine, oleyl amine, steryl amine, cyclo hexyl amine, abetyl amine, picolin, pyridine and its higher homologues; 2-amino pyridine, piperazene, ethylene diamine, diethylene tri-amine, triethylene tetra-amine; polyamines such as n-alkyl propylene diamine where alkyl group is selected from C₂ to C₂₄ or combinations thereof.

14. The pressurized ball point pen ink composition as claimed in claim 1, wherein the diols or polyols are selected from ethylene glycol, propylene glycol, di-ethylene glycol, di-propylene glycol and poly ethylene oxide derivatives, polypropylene oxide derivatives, co condensates of ethylene oxide and propylene oxide, random or block copolymers of ethylene oxide and propylene oxide ranging from 200 to 2000 molecular weights, glycerine, ethylene oxide condensates of glycerin, penia erythritol and its ethylene oxide condensates and propylene oxide condensates, random or block copolymers of polycondensation products from 2 to 200 moles, sorbitol, hexitol, butane-1,4-diol, butane-1,2-diol, butane-1,3-diol, 2-methyl pentane-1,5-diol, hexane-1,6-diol, octane-1,8-diol, decane-1,10-diol or dodecane-1,12-diol or combination thereof.

15. The pressurized ball point pen ink composition as claimed in claim 14, wherein the amines used in the ink composition is preferably 0.2 to 2.5% wt/wt.

16. The pressurized ball point pen ink composition as claimed in claim 15, wherein the diols and/or polyols used in the ink composition is preferably 0.2 to 10% wt/wt.

17-31. (canceled)

32. A ball point pen comprising the ink composition having viscosity about 10 K to 45 K cps as claimed in claim 1 which preventing leakage, bobbling, gooping, gobbling and gives pleasure in writing being smooth.

33. A ball point pen comprising the ink composition having viscosity below 10000 cps as claimed in claim 1 which prevents leakage, bobbling, gooping, gobbling and gives pleasure in writing smoothly.
